(19) United States
(12) Patent Application Publication
(10) Pub. No.: US 2020/0070178 A1
(43) Pub. Date: Mar. 5, 2020

(54) APPARATUS FOR PROCESSING WET AGGREGATE MATERIAL

(71) Applicant: CDE Global Limited, Cookstown (GB)

(72) Inventor: Eoin Heron, Cookstown (GB)

(21) Appl. No.: 16/445,860

(22) Filed: Jun. 19, 2019

(30) Foreign Application Priority Data
Jun. 20, 2018 (GB) 1810103.0

(51) Int. Cl. B03B 5/40

(52) U.S. Cl. CPC B03B 5/40

(57) ABSTRACT

An apparatus for processing wet aggregate material includes a trough mounted at an inclined angle and a pair of parallel shafts being rotatably mounted within the trough. Each shaft has a plurality of agled blades mounted thereon so that the blades carry aggregate material within the trough towards an upper end of the trough when the shafts are rotated. At least one weir is provided in a side wall of the trough adjacent a lower end thereof, through which excess water and any floating trash within the trough may pass. Fluid outlets provided in the trough communicate with a fluid supply such that fluid exiting from the fluid outlets creates an upward flow in the trough pushing particles of light material, organics and floatables to the top surface of the water to pass out of the trough via the at least one weir.

### FIELD OF THE INVENTION

This invention relates to an apparatus for processing wet aggregate material and in particular to an apparatus for removing light contaminants (known as “trash”) from aggregate material.

### BACKGROUND OF THE INVENTION

In the production of aggregate materials, such as sand, gravel, crushed rock, scalpings and iron and other mineral ores, the desired product material will often be contaminated with clay or other soils, organic material, such as grass, roots, and small wood or tree branch fragments, and man-made waste materials, such as light plastics. In order to prepare such aggregate product material for market, it is necessary to process the product material so that it is free from such contaminants.

When cleaning heavily contaminated aggregate materials this is often achieved in what is known as a “logwasher”. A logwasher typically includes a trough mounted at an inclined angle relative to horizontal to which water is added, the feed material being delivered into a lower end of the trough. A pair of parallel shafts or logs are rotatably mounted within the trough and are driven to rotate in opposite directions. Each shaft has a plurality of paddles or blades mounted thereon, usually mounted to the shaft at an angle, the paddles on adjacent shafts being staggered so that mud balls and other clumps of material are broken down by attrition of the material between the blades of the adjacent shafts. The blades are angled so that they carry the product material towards the raised end of the trough, where the separated and washed product material is discharged, typically onto a grading and/or dewatering screen.

Light contaminants separated from the product material, typically including grass, roots, twigs and light plastics, (known as “trash”) typically float on top of the water in the trough. It is known to provide a weir in the lower end wall of the trough, such weir defining the maximum water level within the trough, while excess water and floating trash may pass over the weir to exit the trough.

However, known logwashers rely on the trash to float on top of the water for it to be removed via the weirs. Often the trash can be contaminated with heavier waste or simply blocked from reaching the water surface by the aggregate itself or other solid contamination in the water.

### SUMMARY OF THE INVENTION

According to a first aspect of the present invention there is provided an apparatus for processing wet aggregate material including a trough mounted at an inclined angle, a pair of parallel shafts being rotatably mounted within the trough extending from a lower to an upper end of the trough, and a driver or drive means being provided for driving the shafts in opposite directions. Each shaft has a plurality of blades mounted thereon, wherein the blades are angled so that they carry aggregate material within the trough towards an upper end of the trough when the shafts are rotated by the driver in a normal direction of rotation. At least one weir is provided in a side wall of the trough, adjacent a lower end thereof, through which excess water and any floating trash within the trough may pass. The at least one weir defines a normal water level within the trough during operation of the apparatus, wherein fluid outlets provided in the trough communicate with a fluid supply such that a fluid exiting from the fluid outlets creates an upward flow in the trough that pushes particles of light material, organics and floatables to the top surface of the water to pass out of the trough via the at least one weir.

In a another aspect, the fluid exiting the fluid outlets includes water. Alternatively it is envisaged that the fluid may include air.

The fluid outlets may be provided in at least one fluid manifold located on or adjacent a bottom wall of the trough. At least one fluid manifold may be provided at or adjacent the lower end of the trough. At least one pair of elongate fluid manifolds may be provided adjacent and parallel to one another, the fluid outlets being provided in respective facing sides of the (or each) pair of manifolds such that the fluid outlets of one manifold of the pair face the fluid outlets of a second manifold of the (or each) pair. In one embodiment a first pair of elongate fluid manifolds may be mounted on the bottom wall of the trough adjacent the lower end of the trough and a second pair of elongate fluid manifolds may be mounted on the bottom wall of the trough between the first pair of manifolds and upper end of the trough. A shield member may be mounted above each fluid outlet to extend over the fluid outlets to prevent aggregate from blocking the fluid outlets. The shield member may be defined by a plate mounted on top of each manifold.

The fluid outlets and/or manifolds may be arranged so that the flow of fluid therefrom is directed towards the lower end of the trough to encourage reverse flow of water opposite to the movement of the aggregate towards the upper end of the trough.

Optionally, the blades on the adjacent shafts are staggered such that the blades on the adjacent shafts can pass between one another during rotation of the shafts.

A pair of weirs may be provided on opposite sides of the trough, each weir being arranged to deliver water and floating material from the trough onto the deck of the first dewatering screen.

The height of the at least one weir may be adjustable to adjust the depth of water within the lower end of the trough, for example by adding or removing additional sections or slats.

According to a further aspect of the present invention there is provided a method of processing wet aggregate material including passing aggregate material and water into a trough mounted at an inclined angle and having a pair of parallel shafts rotatably mounted within the trough extending from a lower to an upper end of the trough, each shaft having a plurality of angled blades mounted thereon, at least one weir being provided in a side wall of the trough adjacent a lower end thereof through which excess water and any floating trash within the trough passes, the method including rotating the shafts such that aggregate material within the trough is carried towards an upper end of the trough and adding a fluid to a lower region of the trough to create an upward flow in the trough thereby pushing particles of light material, organics and floatables to the top surface of the water to pass out of the trough via the at least one weir.

The fluid may comprise water. Alternatively it is envisaged that the fluid may comprise air.

The fluid may be added to the trough via one or more fluid outlets. In one embodiment the fluid outlets may be provided in at least one manifold located on or adjacent a bottom wall of the trough. The fluid may be directed from the fluid outlets towards the lower end of the trough to encourage reverse flow of water opposite to the movement of the aggregate towards the upper end of the trough.

These and other objects, advantages, purposes and features of the present invention will become apparent upon review of the following specification in conjunction with the drawings.

### BRIEF DESCRIPTION OF THE DRAWINGS

An apparatus for processing aggregate material in accordance with an embodiment of the present invention will now be described, by way of example only, with reference to the accompanying drawings, in which:—

FIG. 1 is a side view of an aggregate processing apparatus in accordance with an embodiment of the present invention;

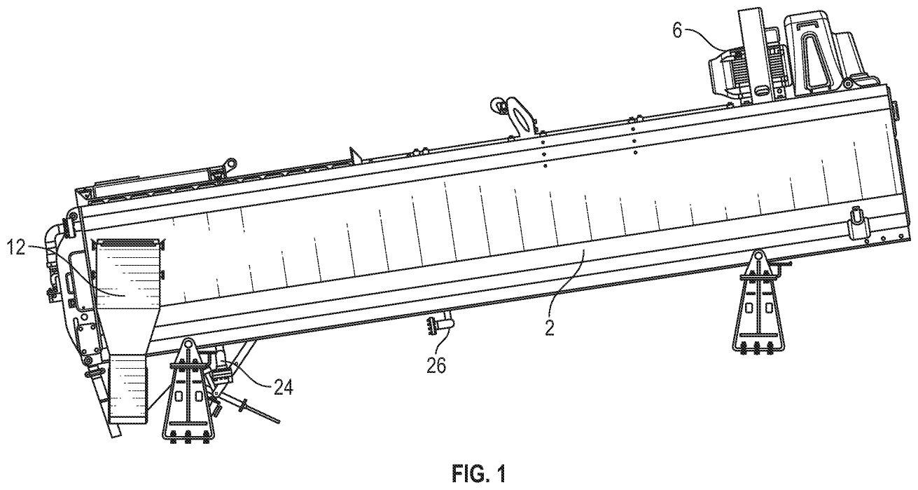

FIG. 2 is side view of the apparatus of FIG. 1 with an outer side removed for clarity;

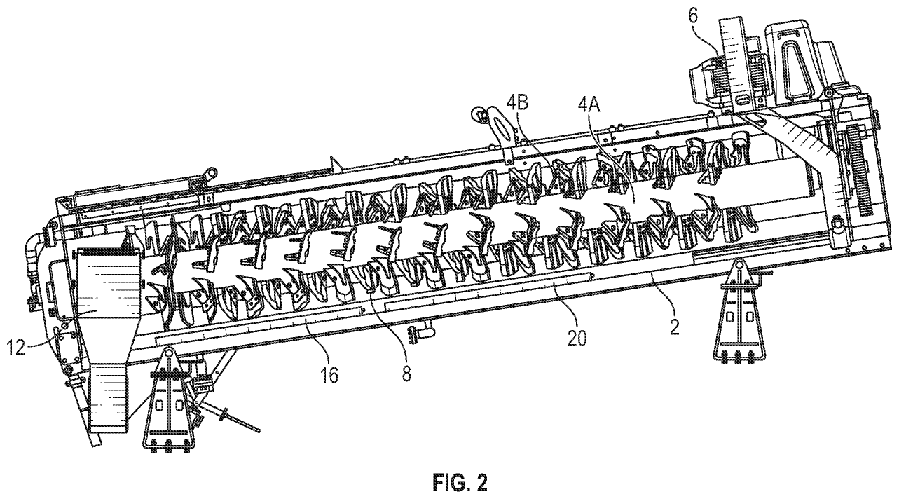

FIG. 3 is a perspective view of the apparatus of FIG. 2;

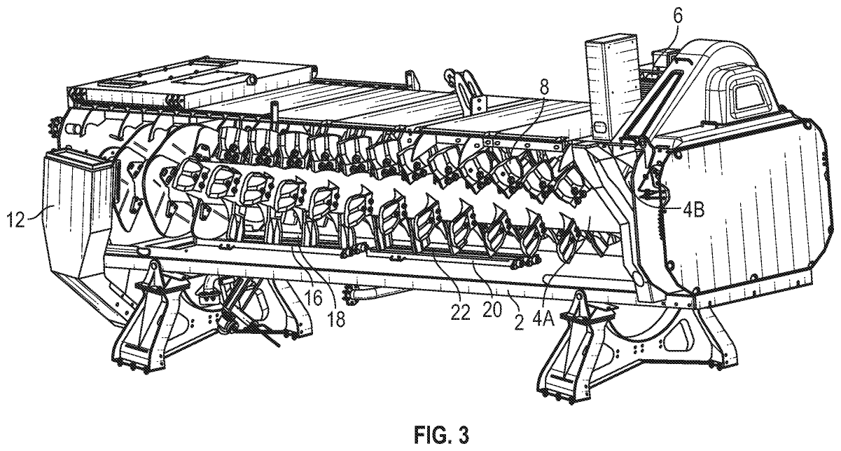

FIG. 4 is a side view of the trough of the apparatus of FIG. 1 with parts removed for clarity;

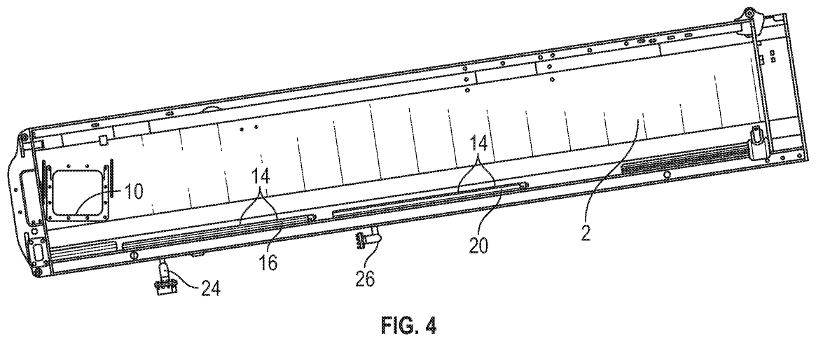

FIG. 5 is a perspective view of the trough of FIG. 4; and

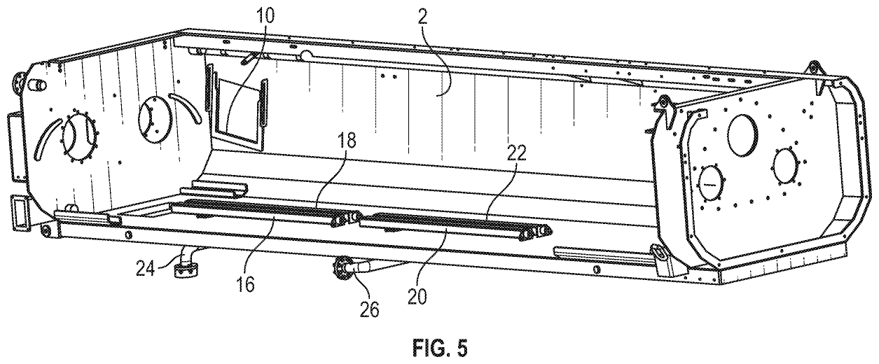

FIG. 6 is a detailed perspective view of the water supply manifold of the apparatus of FIG. 1.

### DETAILED DESCRIPTION OF THE DRAWINGS

An apparatus for processing aggregate material of the type known as a logwasher in accordance with an embodiment of the present invention, as illustrated in the drawings, includes a trough 2 configured to be mounted on a chassis at an inclined angle, a pair of parallel shafts 4A,4B rotatably mounted within the trough 2 extending from a lower to an upper end of the trough 2, an electric motor 6 being provided for driving the shafts 4A,4B in opposite directions via a gearbox or drive belt/chain, each shaft 4A,4B having a plurality of blades 8 mounted thereon. The blades 8 on the adjacent shafts 4A,4B are staggered such that the blades 8 on the adjacent shafts 4A,4B can pass between one another during rotation of the shafts 4A,4B. The blades 8 are angled so that they carry material within the trough towards an upper end of the trough when the shafts are rotated by the motor 6 in a normal direction of rotation while scrubbing the material to separate and break up contamination stuck to the material.

Spray bars (not shown) may be provided for adding water to the trough and a pair of weirs 10 are provided in opposite side walls of the trough 2 at a lower end of the trough 2 over which weirs 10 excess water and any trash floating thereon can pass. The height of the weirs 10 determines the water level within the lower end of the trough 2. It is envisaged that one or more weirs may additionally or alternatively be provided in the rear wall of the lower end of the trough.

Each weir 10 leads to a respective duct 12 on the outer sides of the trough 2 to convey water and trash out of the trough, for example onto the deck of a dewatering screen mounted adjacent the lower end of the trough 2, whereupon the collected trash may be dewatered via a vibratory motion of the deck imparted thereto by a suitable vibration generator or vibration generating means, before being passed onto a conveyor or into a suitable collection receptacle for stockpiling and disposal.

As discussed above, in known logwashers the light trash may be prevented from reaching the surface of the water in the trough 2 by heavy contaminants or the aggregate itself. In an apparatus in accordance with the present invention this problem is overcome by generating an upward flow of water in the lower end of the trough that pushes particles of light material, organics and floatables to the top surface of the water to pass out of the trough via the at least weirs 10.

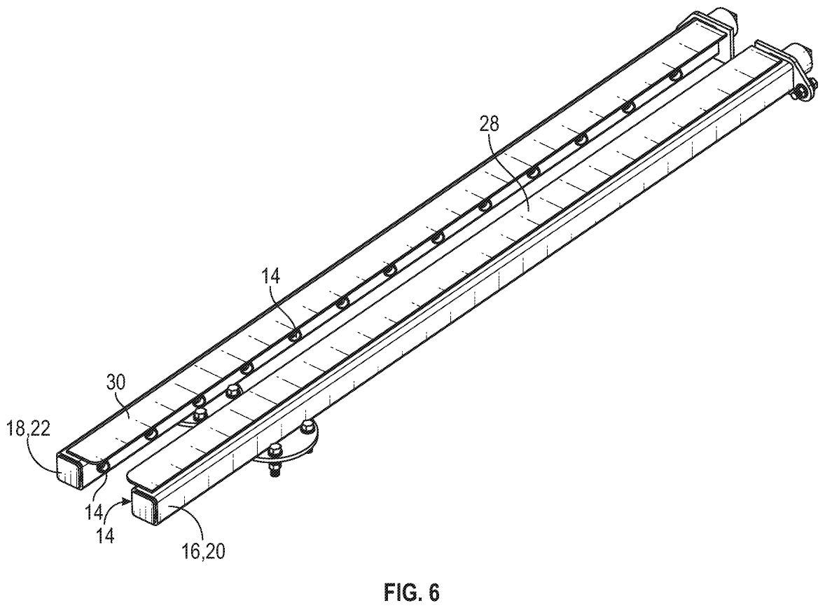

In the embodiment shown in the drawings, the upward flow of water is generated by means of a plurality of water outlet nozzles 14 (see FIG. 6) provided in one or more elongate hollow manifolds 16,18,20,22 mounted on the bottom wall of the trough substantially parallel to the sides of the trough 2. The manifolds 16,18,20,22 may be coupled to a water supply via a couplings 24,26 extending through the bottom wall of the trough 2.

As illustrated in the drawings, the manifolds 16,18,20,22 may be arranged in parallel pairs, the outlet nozzles being provided in a respective side wall of each manifold in each pair such that the outlet nozzles 14 of each pair of manifolds 16,18,20,22 face one another, whereby the water exiting the nozzles 14 converges towards the centre of the trough 2 to flow upwardly between the shafts 4A,4B.

The outlet nozzles and/or the manifolds may be arranged so that the flow of water therefrom is directed towards the lower end of the trough to encourage reverse flow of water opposite to the movement of the aggregate towards the upper end of the trough.

As best illustrated in FIG. 6, a shield plate 28,30 may be mounted on top of each manifold extending over the outlet nozzles therein to protect the outlet nozzles from blockage by debris within the trough 2.

In use, a feed material, including an aggregate material having a range of particle size mixed with clay or other soils and contaminated with organic material, such as grass, roots, and small wood or tree branch fragments, and man-made waste materials, such as light plastics, is fed into the lower end of the trough and the shafts 4A,46 are rotated such that the blades 8 cause attrition of the material, breaking up the clay and soil bound to the aggregate material, causing intense scrubbing to separate the aggregate material from any contamination. The angle of the blades causes the aggregate material to be conveyed up the trough towards and outlet opening at an upper end of the trough 2, from which opening the cleaned aggregate material may fall onto the deck of a grading screen (not shown). During such process water is added to the trough 2 via the outlet nozzles of the manifolds 16,18,20,22 to create an upwards flow within the trough 2. Excess water passes over the weirs 10 and into the ducts 12, along with the light organic material and plastics, collectively referred to as trash, which is pushed upwardly through the water in the trough by the flow of water from the outlet nozzles 14 to float on surface of the water within the trough 2.

The invention is not limited to the embodiment described herein but can be amended or modified without departing from the scope of the present invention, which is intended to be limited only by the scope of the appended claims as interpreted according to the principles of patent law including the doctrine of equivalents.

1. An apparatus for processing wet aggregate material comprises:
a trough mounted at an inclined angle;
a pair of parallel shafts rotatably mounted within said trough and extending from a lower end to an upper end of said trough;
a driver operable to rotate said shafts in opposite directions;
a plurality of blades mounted on each of said shafts, wherein said blades are angled so that they carry aggregate material within said trough towards said upper end of said trough when said shafts are rotated by said driver in a normal direction of rotation;
at least one weir is provided in a side wall of said trough adjacent said lower end thereof, through which excess water and any floating trash within said trough may pass, said at least one weir defining a normal water level within said trough during operation of the apparatus; and
fluid outlets provided in said trough and communicating with a fluid supply such that a fluid exiting from said fluid outlets creates an upward flow in said trough that pushes particles of light material, organics and floatables to the top surface of the water to pass out of said trough via said at least one weir.

2. The apparatus of claim 1, wherein the fluid exiting said fluid outlets comprises water.

3. The apparatus of claim 1, wherein the fluid exiting said fluid outlets comprises air.

4. The apparatus of claim 1, wherein said fluid outlets are provided in at least one fluid manifold located on or adjacent a bottom wall of said trough.

5. The apparatus of claim 4, wherein said at least one fluid manifold is provided at or adjacent said lower end of said trough.

6. The apparatus of claim 4, wherein at least one pair of said fluid manifolds are provided adjacent and parallel to one another, said fluid outlets being provided in respective facing sides of said at least one pair of fluid manifolds such that said fluid outlets of one manifold of said at least one pair of fluid manifolds face said fluid outlets of a second manifold of said at least one pair of fluid manifolds.

7. The apparatus of claim 6, wherein a first pair of said fluid manifolds is mounted on said bottom wall of said trough adjacent said lower end of said trough and a second pair of said elongate fluid manifolds is mounted on said bottom wall of said trough between said first pair of manifolds and upper end of said trough.

8. The apparatus of claim 1, wherein a shield member is mounted above each fluid outlet to extend over said fluid outlets to prevent aggregate from blocking said fluid outlets.

9. The apparatus of claim 8, wherein said fluid outlets are provided in at least one fluid manifold located on or adjacent a bottom wall of said trough, said shield member being defined by a plate mounted on top of each of said fluid manifolds.

10. The apparatus of claim 1, wherein said fluid outlets are arranged so that the flow of fluid therefrom is directed towards said lower end of said trough to encourage reverse flow of water opposite to the movement of the aggregate towards said upper end of said trough.

11. The apparatus of claim 1, wherein said blades on said parallel shafts are staggered such that said blades on said parallel shafts can pass between one another during rotation of said shafts.

12. The apparatus of claim 1, wherein a pair of weirs are provided on opposite sides of said trough, each weir being arranged to deliver water and floating material from said trough onto a deck of a dewatering screen.

13. The apparatus of claim 1, wherein the height of said at least one weir is adjustable to adjust the depth of water within said lower end of said trough.

14. A method of processing wet aggregate material, said method comprising:
passing aggregate material and water into a trough mounted at an inclined angle, the trough having a pair of parallel shafts rotatably mounted within the trough and extending from a lower end to an upper end of the trough, each shaft having a plurality of angled blades mounted thereon, at least one weir being provided in a side wall of the trough adjacent a lower end thereof through which excess water and any floating trash within the trough passes;
rotating the shafts such that aggregate material within the trough is carried towards the upper end of the trough; and
adding a fluid to a lower region of the trough to create an upward flow in the trough thereby pushing particles of light material, organics and floatables to the top surface of the water to pass out of the trough via the at least one weir.

15. The method of claim 14, wherein the fluid comprises water.

16. The method of claim 14, wherein the fluid comprises air.

17. The method of claim 14, wherein the fluid is added to the trough via one or more fluid outlets.

18. The method of claim 17, wherein the fluid outlets are provided in at least one manifold located on or adjacent a bottom wall of the trough.

19. The method of claim 14, wherein the fluid is directed from the fluid outlets towards the lower end of the trough to encourage reverse flow of water opposite to the movement of the aggregate towards the upper end of the trough.
